(19) United States
(12) Patent Application Publication
(10) Pub. No.: US 2016/0165577 A1
(43) Pub. Date: Jun. 9, 2016

(54) SYSTEMS, METHODS, AND DEVICES FOR DOWNLINK SHARED CHANNEL TRANSMISSION FOR MTC USING CONVOLUTIONAL CODING

(71) Applicant: Intel IP Corporation, Santa Clara, CA (US)

(72) Inventors: Alexei Davydov, Nizhny Novgorod (RU); Gang Xiong, Beaverton, OR (US); Debdeep Chatterjee, Mountain View, CA (US)

(73) Assignee: Intel IP Corporation, Santa Clara, CA (US)

(21) Appl. No.: 14/671,635

(22) Filed: Mar. 27, 2015

Related U.S. Application Data
(60) Provisional application No. 62/086,908, filed on Dec. 3, 2014.

(51) Int. Cl. H04W 72/04; H04L 5/00

(52) U.S. Cl. CPC H04W 72/042; H04L 5/0053

(57) ABSTRACT

Systems and methods for transmitting and receiving downlink shared channel (DL-SCH) transmissions encoded with convolutional codes are disclosed herein. User equipment (UE) may be configured to communicatively couple to an Evolved Universal Terrestrial Radio Access Network (E-UTRAN) Node B (eNB). The UE may be configured to transmit and receive machine-type communication (MTC). The eNB may determine that the UE is an MTC UE. The eNB may use a convolutional code typically used for encoding control channel transmission to encode the DL-SCH transmissions. The DL-SCH may be transmitted over a physical downlink shared channel (PDSCH) or may be transmitted over a physical downlink control channel (PDCCH) or enhanced PDCCH (EPDCCH). Downlink control information (DCI) may be transmitted before the DL-SCH and may include information that can be used to decode the DL-SCH. Alternatively, the DL-SCH may be transmitted without first transmitting DCI.

### RELATED APPLICATIONS

This application claims priority to and the benefit of U.S. Provisional Patent Application No. 62/086,908, filed Dec. 3, 2014, which is hereby incorporated by reference herein in its entirety.

### TECHNICAL FIELD

The present disclosure relates to systems, methods, and devices for machine-type communication that use convolutional coding for the downlink shared channel.

### BRIEF DESCRIPTION OF THE DRAWINGS

FIG. 1 is a perspective view of a plurality of UEs communicating with an eNB.

FIG. 2 is a flow diagram of a method of encoding DL-SCH data to be sent to a UE supporting MTC.

FIG. 3 is a schematic diagram of transport layer channels and physical layer channels that may be used for transmitting to a UE.

FIG. 4A is a schematic diagram of an embodiment of an eNB communicating with a UE supporting MTC.

FIG. 4B is a schematic diagram of another embodiment of an eNB communicating with a UE supporting MTC.

FIG. 5A is a flow diagram of an embodiment of a method for receiving DL-SCH transmissions configured for MTC devices.

FIG. 5B is a flow diagram of another embodiment of a method for receiving DL-SCH transmissions configured for MTC devices.

FIG. 6 is a schematic diagram of an embodiment of a UE able to receive MTC transmissions from an eNB.

### DETAILED DESCRIPTION OF PREFERRED EMBODIMENTS

Wireless mobile communication technology uses various standards and protocols to transmit data between a base station and a wireless communication device. Wireless communication system standards and protocols can include, for example, the 3rd Generation Partnership Project (3GPP) long term evolution (LTE); the Institute of Electrical and Electronics Engineers (IEEE) 802.16 standard, which is commonly known to industry groups as worldwide interoperability for microwave access (WiMAX); and the IEEE 802.11 standard, which is commonly known to industry groups as Wireless Local Area Network (WLAN) or Wi-Fi. In 3GPP radio access networks (RANs) in LTE systems, a base station may include Evolved Universal Terrestrial Radio Access Network (E-UTRAN) Node Bs (also commonly denoted as evolved Node Bs, enhanced Node Bs, eNodeBs, or eNBs) and/or Radio Network Controllers (RNCs) in an E-UTRAN, which communicate with a wireless communication device, known as user equipment (UE). In LTE networks, an E-UTRAN may include a plurality of eNodeBs and may communicate with a plurality of UEs. An evolved packet core (EPC) may communicatively couple the E-UTRAN to an external network, such as the Internet. LTE networks include radio access technology (RAT) and core radio network architecture that can provide high data rate, low latency, packet optimization, and improved system capacity and coverage.

LTE networks may be used to support Machine-Type Communication (MTC) thereby enabling a ubiquitous computing environment (e.g., an “Internet of Things (IoT)”). MTC applications may include smart metering, healthcare monitoring, remote security surveillance, intelligent transportation systems, or the like. Existing mobile broadband networks may be designed to optimize performance mainly for human type communication and thus are not designed or optimized for MTC related requirements. For example, objectives for MTC devices may include lower device cost, enhanced coverage, and reduced power consumption.

Communications between eNBs and MTC UEs may be configured to support these objectives. For example, a reduced UE bandwidth of 1.4 MHz may be used in the downlink (DL) and uplink (UL) directions. The UE may have reduced complexity to support only the reduced bandwidth at the baseband and RF stages. In some embodiments, the bandwidth may be even smaller (e.g., equal to the bandwidth of a single physical resource block (PRB)). The reduced bandwidth may result in a reduction in transport block size (TBS) that can be transmitted in one transmission time interval (TTI). For example, for a resource allocation of one PRB pair, the maximum TBS may be 280 bits in some embodiments.

Multiple different kinds of channel coding may be used for communications between the eNB and the UE. For example, the channel coding may include convolutional turbo coding, convolutional coding, and/or the like. As used herein, the term convolutional coding is defined to refer to convolutional coding that does not include turbo coding. In some embodiments, convolutional turbo coding may be used for channel coding on a physical downlink shard channel (PDSCH) and convolutional coding may be used for enhanced physical downlink control channels (PDCCH/EPDCCH). Convolutional turbo coding may provide better performance over convolutional coding for large TBS. For small TBS (e.g., on the order of 50, 100, 200, 500 bits, or the like), the performance difference may be negligible. Accordingly, the additional complexity of supporting multiple channel coding schemes may provide little benefit to low-cost MTC UEs that support narrow bandwidth transmission with small transport block sizes.

An eNB may be configured to transmit downlink shared channel (DL-SCH) transmissions with convolutional coding applied to the transmission. For example, the eNB may be configured to apply convolutional turbo coding to PDSCH and convolutional coding to PDCCH/EPDCCH when communicating with an ordinary UE. However, if the eNB determines that the UE is an MTC UE, it may apply convolutional coding to DL-SCH transmissions. In an embodiment, the eNB may decode an attach request from a UE that identifies the UE. The eNB may determine whether the UE is an MTC UE from the identifying information and thereby determine how to encode the DL-SCH.

The DL-SCH may be transmitted over the PDSCH or the PDCCH/EPDCCH in various embodiments. Convolutional coding may be applied regardless of whether the DL-SCH is transmitted over the PDSCH or the PDCCH/EPDCCH (e.g., mapped to resources of the PDSCH or the PDCCH/EPDCCH). In some embodiments, the DL-SCH may be transmitted over a low cost physical downlink shared channel (LC-PDSCH). For example, the LC-PDSCH may occupy the same time-frequency resources as the conventional PDSCH, but the LC-PDSCH may use convolutional coding instead of convolutional turbo coding.

In embodiments where the DL-SCH is transmitted over the PDCCH/EPDCCH, downlink control information (DCI) may or may not be transmitted over the PDCCH/EPDCCH prior to transmitting the DL-SCH. For example, the UE may monitor the UE-specific search space for a DCI transmission indicating information about the PDCCH/EPDCCH based DL-SCH transmission and/or indicating transmission of the DL-SCH using the PDCCH/EPDCCH. The DCI may include a TBS index, a hybrid automatic repeat request (HARQ) process number (e.g., if transmission of multiple HARQ processes is supported), a new data indicator, a radio network temporary identifier (RNTI) (e.g., an RNTI explicitly encoded in a cyclic redundancy check (CRC)), an aggregation level of the EPDCCH used for DL-SCH transmission, and/or the like. The DL-SCH may be transmitted in resource elements following in a logical domain resource elements on which the DCI is transmitted (e.g., immediately following in the logical domain).

Alternatively, DCI may not be transmitted, and the UE may monitor the UE-specific search space for DL-SCH transmissions. In such an embodiment, a single HARQ process number may be assumed, the number of HARQ retransmission may be predetermined (e.g., always fixed to 1, 2, 4, 8, 16, etc.), the TBS may be predetermined (e.g., fixed to a set of N possible values, such as 32, 64, 128, 256, etc. bits), and/or the like. Accordingly, such information may not need to be indicated to the UE by the eNB. A one bit new data indicator may be explicitly encoded in a CRC together with the RNTI.

In an embodiment, the DL-SCH may be encoded in a maximum size of one transport block. For each transport block, a CRC may first be added to the transport block. Next, convolutional coding may be applied to the transport block with CRC. Rate matching may be applied to the convolutionally encoded transport block to achieve a desired coding sequence length. The rate matched transport block may be mapped to physical resources of a downlink subframe (e.g., a PDSCH subframe, a PDCCH/EPDCCH subframe, or the like). The downlink subframe may be transmitted to the MTC UE. In some embodiments, the convolutional coding and rate matching may correspond to the PDCCH and/or the EPDCCH.

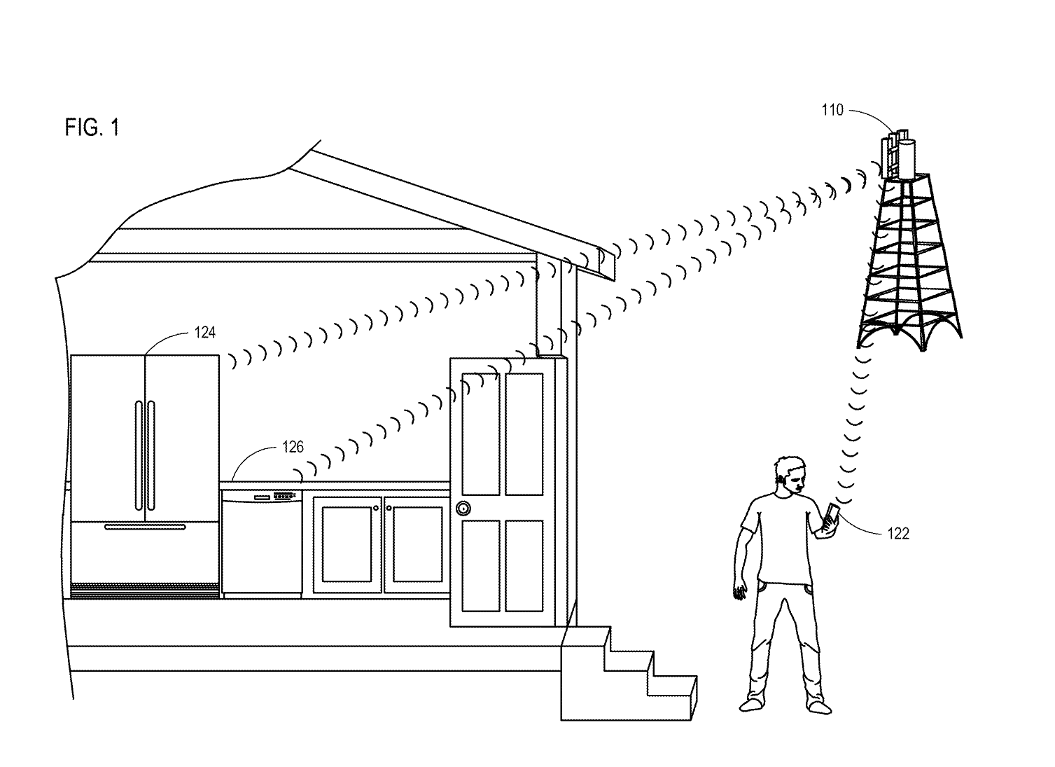

FIG. 1 is a perspective view of a plurality of UEs 122, 124, 126 communicating with an eNB 110. A first UE 122 may be configured to support human type communication. For example, the UE 122 may send or receive Internet traffic, voice traffic, voice over Internet Protocol traffic, etc. The UE 122 may require a large bandwidth to support the human type communication traffic that it receives from the eNB 110. The eNB 110 may transmit PDSCH data in large transport block sizes for which convolutional turbo coding may maximize data throughput. The eNB 110 may also transmit PDCCH/EPDCCH data using convolutional coding. The UE 122 may be configured to decode convolutionally coded data as well as convolutionally turbo coded data. The benefits of higher data throughput may outweigh the costs of the additional complexity required to decode convolutional turbo codes.

The second and third UEs 124, 126 may be configured to support MTC. For example, the UEs 124, 126 may be IoT devices, such as smart appliances. The UEs 124, 126 may receive only small amounts of data and may not require a large data throughput. Accordingly, the bandwidth and TBS of transmissions from the eNB 110 to the UEs 124, 126 may be small. The benefits of convolutional turbo coding may be minimal for the UEs 124, 126 especially for the smaller TBS for which the performance of convolutional turbo codes is not much better and sometimes worse than the performance of convolutional codes. The UEs 124, 126 may be configured to support decoding of convolutional codes only. The cost and energy consumption of the UEs 124, 126 may be reduced by not including a turbo coding receiver in the UEs 124, 126.

The eNB 110 may need to differentiate between the UE 122 configured to support human type communication and the UEs 124, 126 that support MTC so that the eNB 110 uses the proper channel coding for each device. In some embodiments, the UEs 122, 124, 126 may transmit an attach request to the eNB 110 when initially connecting to the E-UTRAN. The attach request may include identifying information from which the eNB 110 can determine with which type of UE it is communicating. The eNB 110 may encode DL-SCH data to the UEs 122, 124, 126 with error correction coding selected based on the type of UE. The convolutional coding used by the eNB 110 to encode DL-SCH data to the UEs 124, 126 that support MTC may be the same as the convolutional coding used to encode PDCCH/EPDCCH transmissions to the UE 122 that support human type communication. Accordingly, minimal modifications may be required to the eNB 110 to support communications with UEs 124, 126 that support MTC. Similarly, the UEs 124, 126 that support MTC may include receivers that share many common elements with the UE 122 that supports human type communication, so the design costs for the UEs 124, 126 that support MTC may be minimal.

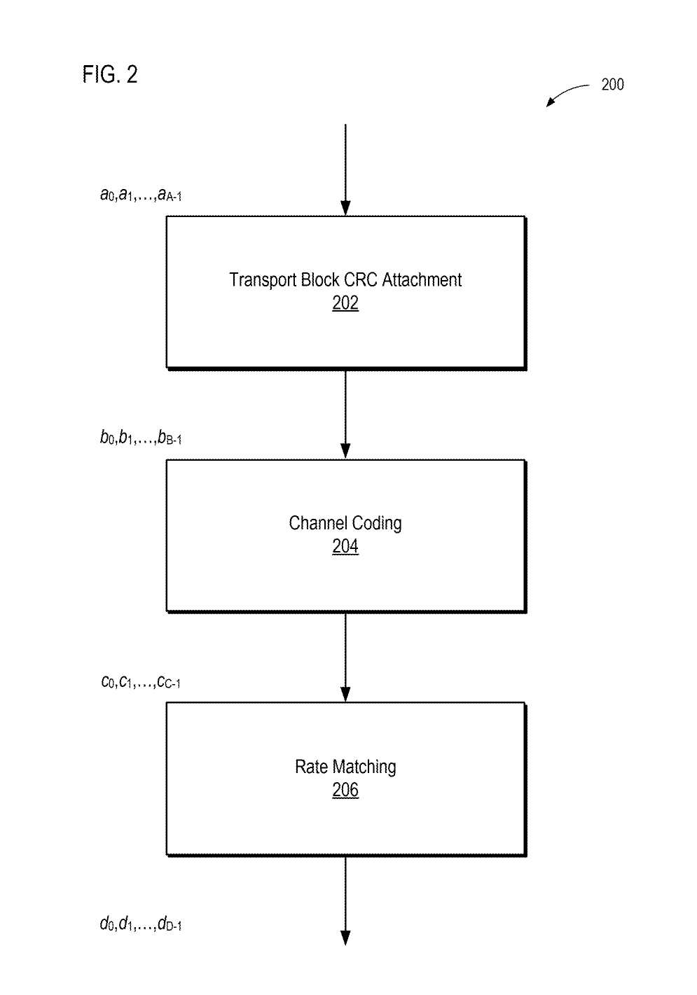

FIG. 2 is a flow diagram of a method 200 of encoding DL-SCH data to be sent to a UE supporting MTC. The method 200 may begin with receiving a transport block to be encoded that includes the bits a₀, a₁, . . . , a_{A-1}. A CRC may be computed from the bits of the transport block, and the CRC may be attached 202 to the transport block to generate a set of bits b₀, b₁, . . . , b_{B-1}. In some embodiments, the CRC may be computed in the same manner as used to compute the CRC for control channel data to be transmitted to a UE supporting human type communication over PDCCH/EPDCCH. Channel coding may be applied 204 to the transport block with the CRC to generate an encoded set of bits c₀, c₁, . . . , c_{C-1}. In some embodiments, the channel coding may be computed in the same manner as used to compute the channel coding for control channel data to be transmitted to a UE supporting human type communication over PDCCH/EPDCCH. Rate matching may be applied 206 to the channel coded bits to generate a rate matched set of bits d₀, d₁, . . . , d_{D-1}. In some embodiments, the rate matching may be computed in the same manner as used to compute the rate matching for control channel data to be transmitted to a UE supporting human type communication over PDCCH/EPDCCH. The encoded and rate matched DL-SCH data may be modulated and transmitted to the UE.

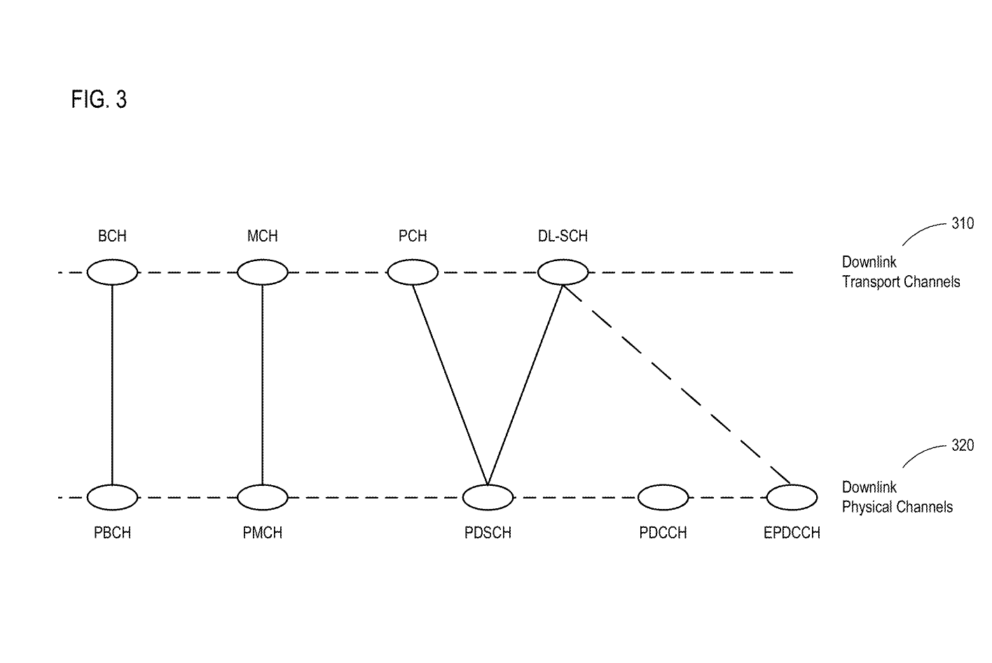

FIG. 3 is a schematic diagram of transport layer channels 310 and physical layer channels 320 that may be used for transmitting to a UE. Various physical channels may be used for transmitting DL-SCH data to a UE supporting MTC. The eNB may map the DL-SCH data to resource blocks of the physical channel being used. For example, in an embodiment, DL-SCH data that has been encoded and rate matched in a manner corresponding to PDCCH/EPDCCH encoding and rate match may be transmitted to the UE supporting MTC using PDSCH as indicated by the solid line connecting DL-SCH to PDSCH. In some embodiments, an LC-PDSCH may be used rather than the PDSCH. The LC-PDSCH may occupy the same time-frequency blocks as the PDSCH but may use convolutional coding rather than convolutional turbo coding. Alternatively, the DL-SCH may be transmitted using PDCCH and/or EPDCCH. In some embodiments, only PDSCH or only PDCCH/EPDCCH may be used to transmit the DL-SCH to the UE supporting MTC. Alternatively, the eNB may select between PDSCH and PDCCH/EPDCCH.

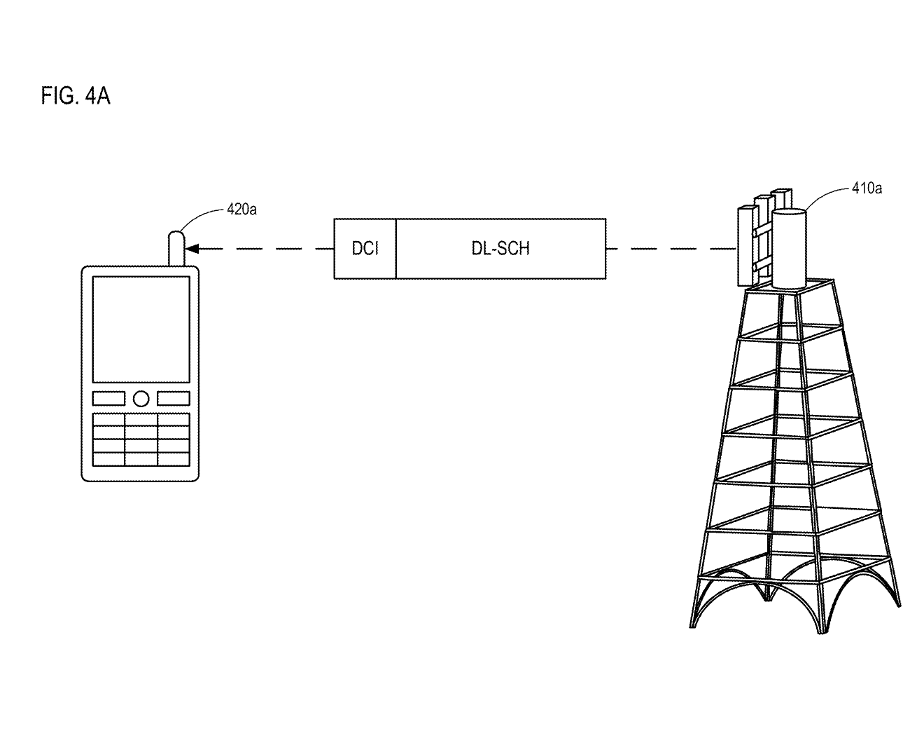

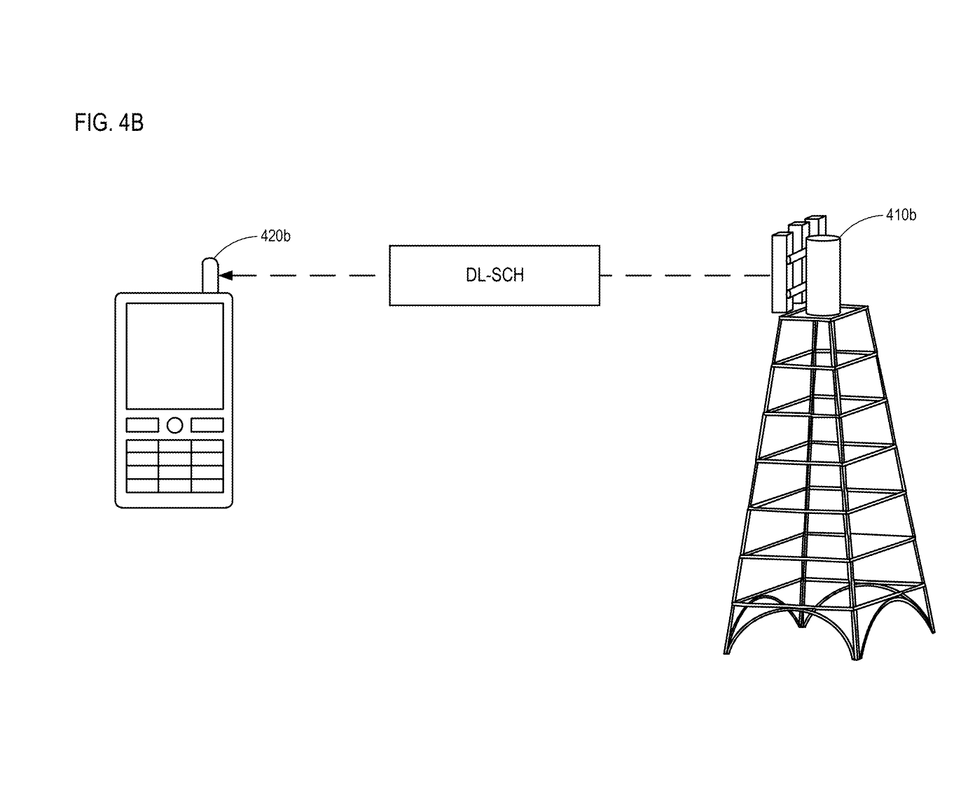

FIG. 4A is a schematic diagram of an embodiment of an eNB 410a communicating with a UE 420a supporting MTC. The eNB 410a may transmit DL-SCH data to the UE 420a using PDCCH/EPDCCH. The eNB 410a may transmit DCI to the UE 420a in a logical domain location preceding a location of the DL-SCH data. For example, the eNB 410a may transmit the DCI, which may indicate that the DL-SCH is being transmitted using PDCCH/EPDCCH and/or information needed by the UE 420a to decode the PDCCH/EPDCCH based transmission of the DL-SCH. For example, the DCI may include a TBS index, a HARQ process number, a new data indicator, an RNTI explicitly coded in a CRC, an aggregation level of the EPDCCH used for DL-SCH transmission, and/or the like. The UE 420a may monitor a UE-specific search space to detect the DCI, for example, by determining the RNTI corresponds to the UE 420a. The UE 420a may use the detected DCI to decode the DL-SCH transmission that follows the DCI in the PDCCH/EPDCCH in the logical domain.

FIG. 4B is a schematic diagram of another embodiment of an eNB 410b communicating with a UE 420b supporting MTC. The eNB 410b may transmit DL-SCH data to the UE 420b using PDCCH/EPDCCH without initially transmitting DCI to the UE. Several parameters needed by the UE 420b to decode the PDCCH/EPDCCH based transmission of the DL-SCH may be predetermined. For example, a single HARQ process number may be assumed and the TBS, number HARQ retransmissions, aggregation level, etc. may be predetermined. The TBS may be fixed to a set of N possible values, such as 32, 64, 128, 256, etc. bits. The number of HARQ retransmissions may be fixed to 1, 2, 4, 8, 16, etc. in some embodiments. A one bit new data indicator may be encoded in the CRC together with the RNTI.

Accordingly, the UE 420b may be able to decode the PDCCH/EPDCCH based transmission of the DL-SCH using the predetermined values and the information encoded in the CRC. The UE 420b may monitor the UE-specific search space to detect the PDCCH/EPDCCH based DL-SCH transmission by detecting the RNTI that corresponds to the UE 420b. When detecting the RNTI, the UE 420b may detect whether the new data indicator is present in the CRC. After determining that the transmission is DL-SCH data intended for the UE 420b, the UE 420b may decode the DL-SCH using the predetermined information, which may be stored locally.

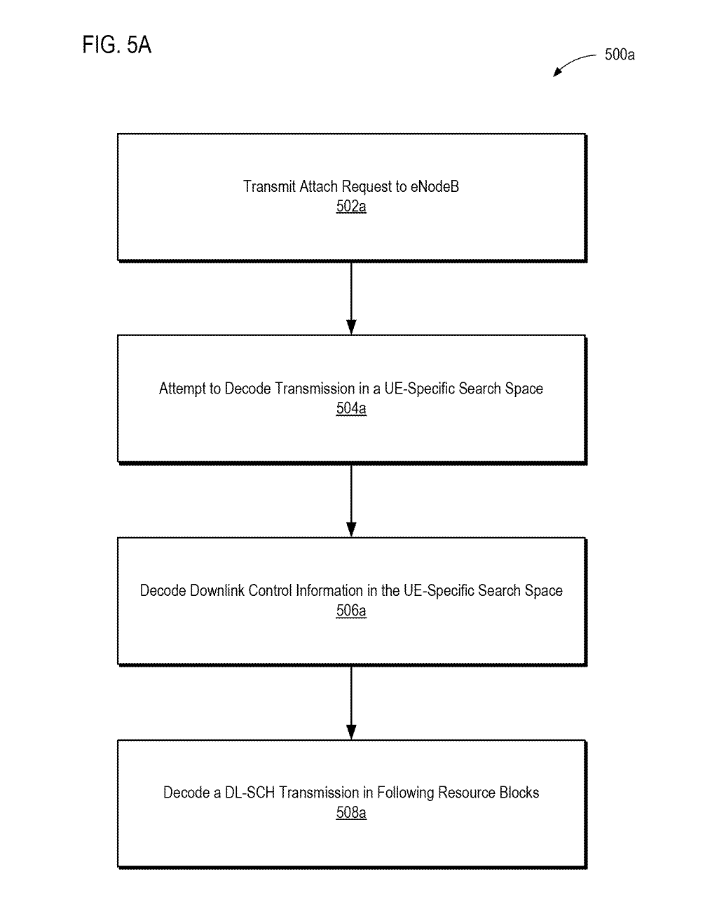

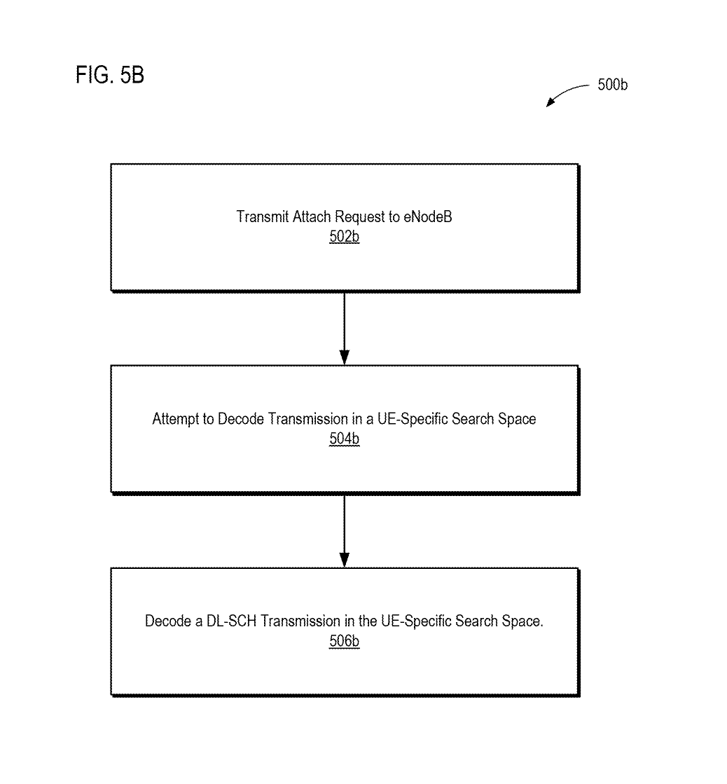

FIG. 5A is a flow diagram of an embodiment of a method 500a for receiving DL-SCH transmissions configured for MTC devices. The method 500a may begin with transmitting 502a an attach request to an eNB. The attach request may include identifying information from which the eNB can determine whether it is communicating with an MTC device or a human type communication device. The eNB may determine how to encode DL-SCH and/or which physical layer channel to use based on whether it has determined that it is communicating with an MTC device or communicating with a human type communication device. For example, the eNB may determine that it should use convolutional coding typically used for encoding PDCCH/EPDCCH transmissions to encode the DL-SCH. In the illustrated embodiment, the PDCCH/EPDCCH may be used to convey the DL-SCH. In alternate embodiments, the DL-SCH may be transmitted over the PDSCH. The method 500a may next include attempting 504a to decode eNB transmissions within a user-specific search space of PDCCH/EPDCCH. Attempting 504a to decode may include determining whether a CRC has been encoded with an assigned RNTI.

If the assigned RNTI is detected, the transmission may be decoded 506a. For example, the transmission may include DCI, which may be decoded 506a. The DCI may include information which can be used to decode DL-SCH transmitted using the PDCCH/EPDCCH. The DCI may include a TBS index, a HARQ process number (e.g., if transmission of multiple HARQ processes is supported), a new data indicator, an RNTI (e.g., an RNTI explicitly encoded in a CRC), an aggregation level of the EPDCCH used for DL-SCH transmission, etc. The DL-SCH may be mapped to resource blocks in the PDCCH/EPDCCH and following the resource blocks in which the DCI was received. The DL-SCH transmitted over the PDCCH/EPDCCH may be decoded 508a using the previously received DCI. Decoding the DL-SCH may include removing convolutional coding applied to the DL-SCH by the eNB. The DL-SCH data may be provided for higher layer processing. The method may end and/or return to attempting 504a to decode transmissions in the UE-specific search space by continuing to monitor for the assigned RNTI. Another set of DCI and additional DL-SCH data may be decoded each time the assigned RNTI is detected.

FIG. 5B is a flow diagram of another embodiment of a method 500b for receiving DL-SCH transmissions configured for MTC devices. As before, the method 500b may begin with transmitting 502b an attach request to an eNB. The attach request may include identifying information from which the eNB can determine whether it is communicating with an MTC device or a human type communication device. If the eNB determines it is communicating with an MTC device, it may transmit DL-SCH data using the PDCCH/EPDCCH. The PDCCH/EPDCCH may be monitored for DL-SCH data by attempting 504b to decode eNB transmissions in a UE-specific search space. In some embodiments, attempting 504b to decode may include determining whether a CRC has been encoded with an assigned RNTI while determining the value of a new data indicator also used to encode the CRC.

If the assigned RNTI is detected, a DL-SCH transmission encoded with the RNTI and transmitted over the PDCCH/EPDCCH may be decoded 506b. Information needed to decode the DL-SCH transmission other than the new data indicator may already be known. For example, the information may be predefined and/or previously determined. A separate resource block containing DCI may not have been received prior to decoding the DL-SCH data transmitted over PDCCH/EPDCCH. Decoding the DL-SCH transmission may include removing convolutional coding applied to the DL-SCH by the eNB. The DL-SCH data may be provided for higher layer processing. The method may end and/or return to attempting 504b to decode transmissions in the UE-specific search space by continuing to monitor for the assigned RNTI. Additional DL-SCH data may be decoded each time the assigned RNTI is detected again using already known information needed for decoding.

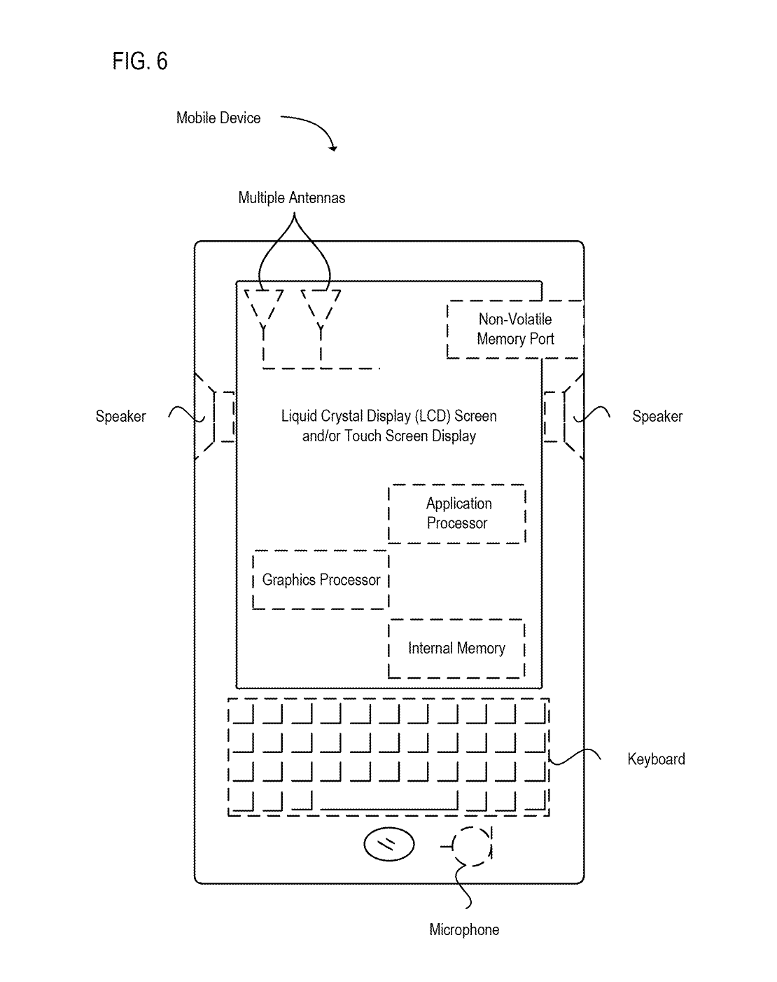

FIG. 6 is an example illustration of a mobile device, such as a UE, a mobile station (MS), a mobile wireless device, a mobile communication device, a tablet, a handset, or another type of wireless communication device. The mobile device can include one or more antennas configured to communicate with a transmission station, such as a base station (BS), an eNB, a base band unit (BBU), a remote radio head (RRH), a remote radio equipment (RRE), a relay station (RS), a radio equipment (RE), or another type of wireless wide area network (WWAN) access point. The mobile device can be configured to communicate using at least one wireless communication standard, including 3GPP LTE, WiMAX, high speed packet access (HSPA), Bluetooth, and Wi-Fi. The mobile device can communicate using separate antennas for each wireless communication standard or shared antennas for multiple wireless communication standards. The mobile device can communicate in a wireless local area network (WLAN), a wireless personal area network (WPAN), and/or a WWAN.

FIG. 6 also provides an illustration of a microphone and one or more speakers that can be used for audio input and output from the mobile device. The display screen may be a liquid crystal display (LCD) screen or other type of display screen, such as an organic light emitting diode (OLED) display. The display screen can be configured as a touch screen. The touch screen may use capacitive, resistive, or another type of touch screen technology. An application processor and a graphics processor can be coupled to internal memory to provide processing and display capabilities. A non-volatile memory port can also be used to provide data input/output options to a user. The non-volatile memory port may also be used to expand the memory capabilities of the mobile device. A keyboard may be integrated with the mobile device or wirelessly connected to the mobile device to provide additional user input. A virtual keyboard may also be provided using the touch screen.

### Examples

The following examples pertain to further embodiments:

Example 1 is an eNB configured to communicate with a UE. The eNB includes a transceiver. The eNB also includes a processor coupled to the transceiver. The processor is configured to decode an attach request from the UE. The attach request identifies the UE. The processor is configured to determine that the UE is an MTC device based on the attach request. The processor is also configured to instruct the transceiver to apply convolutional coding to DL-SCH transmissions to the UE.

In Example 2, the processor of Example 1 is configured to instruct the transceiver to transmit the DL-SCH over EPDDCH in a UE-specific search space.

In Example 3, the processor of Example 1 is configured to instruct the transceiver to transmit DCI indicating that the DL-SCH is being transmitted over the EPDCCH.

In Example 4, the processor of Example 3 is configured to instruct the transceiver to transmit the DL-SCH in resource elements following in a logical domain resource elements in which the DCI is transmitted.

In Example 5, the DCI of any of Examples 3-4 includes information selected from the group consisting of an aggregation level for the DL-SCH and a transport block size for the DL-SCH.

In Example 6, the processor of Example 2 is configured to instruct the transceiver to transmit the DL-SCH over the EPDDCH without transmitting DCI indicating that the DL-SCH is being transmitted over the EPDCCH.

In Example 7, the processor of Example 6 is configured to instruct the transceiver to explicitly encode a new data indicator into a CRC for the transmitted DL-SCH.

In Example 8, the convolutional coding of the DL-SCH and rate matching of the DL-SCH of any of Examples 1-7 correspond to convolutional coding and rate matching of EPDCCH.

Example 9 is a method of communicating with a wireless base station. The method includes transmitting, using a wireless communication device, information identifying the wireless communication device to the wireless base station. The information identifying the wireless communication device indicates that the wireless communication device is a reduced complexity device. The method also includes decoding a transport layer shared channel transmission from the wireless base station. The transport layer shared channel transmission is encoded with error correction coding for reduced complexity devices.

In Example 10, decoding the transport layer shared channel transmission of Example 9 includes receiving the transport layer shared channel over a physical layer shared channel.

In Example 11, decoding the transport layer shared channel transmission of any of Examples 9-10 includes receiving the transport layer shared channel over a low cost physical layer shared channel. The low cost physical layer shared channel occupies the same time-frequency resources as a physical layer shared channel. The low cost physical layer channel is encoded by convolutional coding.

In Example 12, decoding the transport layer shared channel transmission of Example 9 includes receiving the transport layer shared channel over a physical layer control channel.

In Example 13, the method of Example 12 includes decoding control information. The control information indicates the transport layer shared channel transmission will be mapped to the physical layer control channel.

In Example 14, the transport layer shared channel transmission of Example 13 is transmitted in a next logical location in the physical layer control channel after the control information.

In Example 15, the control information of any of Examples 13-14 includes an aggregation level and a block size for the transport layer shared channel transmission.

In Example 16, decoding the transport layer shared channel transmission of Example 12 includes decoding the transport layer shared channel transmission without initially decoding control information.

In Example 17, decoding the transport layer shared channel transmission of Example 16 includes decoding a new data indicator encoded into a CRC for the transport layer shared channel transmission.

Example 18 is an apparatus including means to perform a method as described in any of Examples 9-17.

Example 19 is at least one computer-readable storage medium having stored thereon computer-readable instructions, which when executed, implement a method or realize an apparatus as described in any preceding example.

Example 20 is an apparatus for communicating with a base station. The apparatus includes circuitry configured to transmit identifying information to the base station. The circuitry is configured to attempt to decode base station transmissions within a user-specific search space of a physical control channel. The circuitry is also configured to determine whether user data is being transmitted over the physical control channel based on a decoded base station transmission.

In Example 21, the circuitry of Example 20 is configured to determine whether user data is being transmitted over the physical control channel by decoding control information. The control information indicates the user data is being transmitted over the physical control channel.

In Example 22, the circuitry of Example 21 is configured to decode the user data in a next logical location after the control information.

In Example 23, the control information of any of Examples 21-22 indicates a number of data elements in the physical control channel and a block size for the user data.

In Example 24, the circuitry of Example 20 is configured to determine whether user data is being transmitted over the physical control channel by decoding the user data in the user-specific search space.

In Example 25, the circuitry of Example 24 is configured to decode a new data indicator in error correction coding for the user data.

In Example 26, error correction coding of the user data of any of Examples 20-25 corresponds to error correction coding for the physical control channel.

Example 27 is a UE configured to communicate with an E-UTRAN. The UE includes a transceiver and a processor coupled to the transceiver. The processor is configured to instruct the transceiver to transmit an attach request to the E-UTRAN. The attach request includes identifying information. The E-UTRAN determines that the UE is an MTC device based on the attach request. The processor is also configured to decode DL-SCH transmissions encoded with convolutional coding from the E-UTRAN.

In Example 28, the transceiver of Example 27 is configured to receive the DL-SCH over EPDDCH in a UE-specific search space.

In Example 29, the processor of Example 28 is configured to decode DCI indicating that the DL-SCH is being transmitted over the EPDCCH.

In Example 30, the processor of Example 29 is configured to decode the DL-SCH in resource elements following in a logical domain resource elements in which the DCI is transmitted.

In Example 31, the DCI of any of Examples 29-30 includes information selected from the group consisting of an aggregation level for the DL-SCH and a transport block size for the DL-SCH.

In Example 32, the processor of Example 28 is configured to decode the DL-SCH transmitted over the EPDDCH without decoding DCI indicating that the DL-SCH is being transmitted over the EPDCCH.

In Example 33, the processor of Example 32 is configured to decode a new data indicator explicitly encoded into a CRC for the transmitted DL-SCH.

In Example 34, the convolutional coding of the DL-SCH and rate matching of the DL-SCH of any of Examples 27-33 correspond to convolutional coding and rate matching of EPDCCH.

Example 35 is a method of communicating with a wireless communication device. The method includes receiving, using a base station, information identifying the wireless communication device. The information identifying the wireless communication device indicates that the wireless communication device is a reduced complexity device. The method includes encoding, using the base station, a transport layer shared channel data with error correction coding for reduced complexity devices. The method also includes transmitting, using the base station, the transport layer shared channel data to the wireless communication device.

In Example 36, transmitting the transport layer shared channel data of Example 35 includes transmitting the transport layer shared channel over a physical layer shared channel.

In Example 37, transmitting the transport layer shared channel data of any of Examples 35-36 includes transmitting the transport layer shared channel data over a low cost physical layer shared channel. The low cost physical layer shared channel occupies the same time-frequency resources as a physical layer shared channel. The low cost physical layer channel is encoded by convolutional coding.

In Example 38, transmitting the transport layer shared channel data of Example 35 includes transmitting the transport layer shared channel data over a physical layer control channel.

In Example 39, the method of Example 38 includes transmitting control information. The control information indicates the transport layer shared channel data will be mapped to the physical layer control channel.

In Example 40, the transport layer shared channel data of Example 39 is transmitted in a next logical location in the physical layer control channel after the control information.

In Example 41, the control information of any of Examples 39-40 includes an aggregation level and a block size for the transport layer shared channel transmission.

In Example 42, transmitting the transport layer shared channel data of Example 38 includes transmitting the transport layer shared channel data without initially transmitting control information.

In Example 43, encoding the transport layer shared channel data of Example 42 includes encoding a new data indicator into a CRC.

Example 44 is an apparatus for communicating with a wireless communication device. The apparatus includes circuitry configured to receive identifying information from the wireless communication device. The circuitry is configured to transmit, within a user-specific search space of a physical control channel, an indication of whether user data is being transmitted over the physical control channel.

In Example 45, the circuitry of Example 44 is configured to transmit the indication of whether user data is being transmitted over the physical control channel by transmitting control information. The control information indicates the user data is being transmitted over the physical control channel.

In Example 46, the circuitry of Example 45 is configured to transmit the user data in a next logical location after the control information.

In Example 47, the control information of any of Examples 45-46 indicates a number of data elements in the physical control channel and a block size for the user data.

In Example 48, the circuitry of Example 44 is configured to transmit the indication of whether user data is being transmitted over the physical control channel by transmitting the user data in the user-specific search space.

In Example 49, the circuitry of Example 48 is configured to encode a new data indicator in error correction coding for the user data.

In Example 50, error correction coding of the user data of any of Examples 44-49 corresponds to error correction coding for the physical control channel.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium, wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. The eNB (or other base station) and UE (or other mobile station) may also include a transceiver component, a counter component, a processing component, and/or a clock component or timer component. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another, but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the disclosure is not to be limited to the details given herein, but may be modified within the scope and equivalents of the appended claims.

Those having skill in the art will appreciate that many changes may be made to the details of the above-described embodiments without departing from the underlying principles of the disclosure. The scope of the present application should, therefore, be determined only by the following claims.

1. An evolved universal terrestrial radio access network (E-UTRAN) Node B (eNB) configured to communicate with User Equipment (UE), the eNB comprising:
a transceiver; and
a processor coupled to the transceiver, the processor configured to:
decode an attach request from the UE, wherein the attach request identifies the UE;
determine that the UE is a machine-type communication (MTC) device based on the attach request; and
instruct the transceiver to apply convolutional coding to downlink shared channel (DL-SCH) transmissions to the UE.

2. The eNB of claim 1, wherein the processor is configured to instruct the transceiver to transmit the DL-SCH over an enhanced physical downlink control channel (EPDDCH) in a UE-specific search space.

3. The eNB of claim 2, wherein the processor is configured to instruct the transceiver to transmit downlink control information (DCI) indicating that the DL-SCH is being transmitted over the EPDCCH.

4. The eNB of claim 3, wherein the processor is configured to instruct the transceiver to transmit the DL-SCH in resource elements following in a logical domain resource elements in which the DCI is transmitted.

5. The eNB of claim 3, wherein the DCI includes information selected from the group consisting of an aggregation level for the DL-SCH and a transport block size for the DL-SCH.

6. The eNB of claim 2, wherein the processor is configured to instruct the transceiver to transmit the DL-SCH over the EPDDCH without transmitting downlink control information (DCI) indicating that the DL-SCH is being transmitted over the EPDCCH.

7. The eNB of claim 6, wherein the processor is configured to instruct the transceiver to explicitly encode a new data indicator into a cyclic redundancy check (CRC) for the transmitted DL-SCH.

8. The eNB of claim 1, wherein the convolutional coding of the DL-SCH and rate matching of the DL-SCH correspond to convolutional coding and rate matching of an enhanced physical downlink control channel (EPDCCH).

9. A method of communicating with a wireless base station, the method comprising:
transmitting, using a wireless communication device, information identifying the wireless communication device to the wireless base station, wherein the information identifying the wireless communication device indicates that the wireless communication device is a reduced complexity device; and
decoding a transport layer shared channel transmission from the wireless base station, wherein the transport layer shared channel transmission is encoded with error correction coding for reduced complexity devices.

10. The method of claim 9, wherein decoding the transport layer shared channel transmission comprises receiving the transport layer shared channel over a physical layer shared channel.

11. The method of claim 9, wherein decoding the transport layer shared channel transmission comprises receiving the transport layer shared channel over a low cost physical layer shared channel, wherein the low cost physical layer shared channel occupies the same time-frequency resources as a physical layer shared channel, and wherein the low cost physical layer channel is encoded by convolutional coding.

12. The method of claim 9, wherein decoding the transport layer shared channel transmission comprises receiving the transport layer shared channel over a physical layer control channel.

13. The method of claim 12, wherein further comprising decoding control information, wherein the control information indicates the transport layer shared channel transmission will be mapped to the physical layer control channel.

14. The method of claim 13, wherein the transport layer shared channel transmission is transmitted in a next logical location in the physical layer control channel after the control information.

15. The method of claim 13, wherein the control information comprises an aggregation level and a block size for the transport layer shared channel transmission.

16. The method of claim 12, wherein decoding the transport layer shared channel transmission comprises decoding the transport layer shared channel transmission without initially decoding control information.

17. The method of claim 16, wherein decoding the transport layer shared channel transmission comprises decoding a new data indicator encoded into a cyclic redundancy check (CRC) for the transport layer shared channel transmission.

18. An apparatus for communicating with a base station, the apparatus comprising circuitry configured to:
transmit identifying information to the base station;
attempt to decode base station transmissions within a user-specific search space of a physical control channel; and
determine whether user data is being transmitted over the physical control channel based on a decoded base station transmission.

19. The apparatus of claim 18, wherein the circuitry is configured to determine whether user data is being transmitted over the physical control channel by decoding control information, wherein the control information indicates the user data is being transmitted over the physical control channel.

20. The apparatus of claim 19, wherein the circuitry is configured to decode the user data in a next logical location after the control information.

21. The apparatus of claim 19, wherein the control information indicates a number of data elements in the physical control channel and a block size for the user data.

22. The apparatus of claim 18, wherein the circuitry is configured to determine whether user data is being transmitted over the physical control channel by decoding the user data in the logical location.

23. The apparatus of claim 22, wherein the circuitry is configured to decode a new data indicator in error correction coding for the user data.

24. The apparatus of claim 18, wherein error correction coding of the user data corresponds to error correction coding for the physical control channel.
